(19) United States
(12) Patent Application Publication
(10) Pub. No.: US 2007/0164151 A1
(43) Pub. Date: Jul. 19, 2007

(54) Aircraft shock strut and improved bearings therefor

(76) Inventor: William E. Luce, Colleyville, TX (US)

Correspondence Address: Renner, Otto, Boisselle & Sklar, 19th Floor, 1621 Euclid Ave., Cleveland, OH, 44115, US

(21) Appl. No.: 11/331,506

(22) Filed: Jan. 13, 2006

(51) Int. Cl. B64C 25/00; F16F 7/00

(52) U.S. Cl. 244/100 R

(57) ABSTRACT

An aircraft shock strut includes a cylinder and a piston telescopically movable within the cylinder. A first bearing is mounted to one of the cylinder and the piston. The first bearing includes a support structure and a first bearing surface formed by a lead-free PTFE material layer for providing sliding engagement with the other of the cylinder and the piston.

### FIELD OF THE INVENTION

The present invention relates to aircraft shock struts for absorbing and damping shock forces, such as during landing, taxiing or takeoff, and particularly improved bearings for an aircraft shock strut.

### BACKGROUND OF THE INVENTION

Shock absorbing devices are used in a wide variety of vehicle suspension systems for controlling motion of the vehicle and its tires with respect to the ground and for reducing transmission of transient forces from the ground to the vehicle. Shock absorbing struts are a common and necessary component in most aircraft landing gear assemblies. The shock struts used in the landing gear of aircraft generally are subject to more demanding performance requirements than most if not all ground vehicle shock absorbers. In particular, shock struts must control motion of the landing gear, and absorb and damp loads imposed on the gear during landing, taxiing and takeoff.

A shock strut generally accomplishes these functions by compressing a fluid within a sealed chamber formed by hollow telescoping cylinders. Typically, at least two bearing assemblies provide for sliding engagement of the telescoping cylinders. The fluid generally includes both a gas and a liquid, such as hydraulic fluid or oil. One type of shock strut generally utilizes an “air-over-oil” arrangement wherein a trapped volume of gas is compressed as the shock strut is axially compressed, and a volume of oil is metered through an orifice. The gas acts as an energy storage device, such as a spring, so that upon termination of a compressing force the shock strut returns to its original length. Shock struts also dissipate energy by passing the oil through the orifice so that as the shock absorber is compressed or extended, its rate of motion is limited by the damping action from the interaction of the orifice and the oil.

Over the years, several aircraft have a exhibited a phenomenon where the shock struts would stick, then slip, then stick, etc., during taxi, and especially when letting the aircraft off of a jack. This problem occurs when a shock strut reaches static equilibrium, stops stroking, and takes a significant change in force before the shock strut strokes again. This undesirable phenomenon is often referred to as “stick-slip” or “stiction”. Landing gears that are especially susceptible to stiction are those whose geometry causes high bearing loads under static conditions.

One solution to the stiction problem involved the use of bearing assemblies having low-friction bearing surfaces impregnated with lead. While use of leaded bearing surfaces aids in reducing stiction problems, the leaded bearing assemblies are problematic in that, as the bearing wears, it releases particles of lead within the hydraulic fluid, which cause the fluid to darken. Darkening of hydraulic fluid is problematic because it causes confusion as to the condition of the shock strut during inspections by equipment maintenance personnel.

### SUMMARY OF THE INVENTION

The present invention provides an aircraft shock strut wherein sliding engagement between the cylinder and piston is effected through use of one or more lead-free polytetrafluoroethylene (PTFE) bearing surfaces. Use of bearings having lead-free PTFE bearing surfaces allows for minimization of stick-slip without discoloration of the hydraulic fluid within the shock strut.

More particularly, an aircraft shock strut according to the invention is characterized by a cylinder, a piston telescopically movable within the cylinder, and a first bearing on one of the cylinder and the piston. The first bearing has a first bearing surface providing sliding engagement with the other of the cylinder and the piston. The first bearing comprises a support structure and a porous layer on the support structure. The first bearing surface is formed by an extruded bearing material layer impregnated into the porous layer, wherein the bearing material layer is a continuous consolidated structure comprising a continuous polytetrafluoroethylene (PTFE) matrix and discrete particles of an additive material, and wherein the bearing material layer has a portion above the porous layer.

According to another aspect of the invention, an aircraft shock strut includes a cylinder, a piston telescopically movable within the cylinder, and a first bearing on one of the cylinder and the piston. The first bearing has a first bearing surface providing sliding engagement with the other of the cylinder and the piston. The first bearing surface is formed by a lead-free polytetrafluoroethylene (PTFE) material layer, which has a coefficient of static friction and a coefficient of dynamic friction that differ by less than 0.045 while providing sliding engagement with the other of the cylinder and the piston.

According to another aspect of the invention, there is provided a method of preventing stick-slip in an aircraft landing gear including at least one shock strut, the at least one shock strut including a cylinder and a piston telescopically movable within the cylinder. The method comprises mounting a first bearing to one of the cylinder and the piston, where the first bearing has a first bearing surface formed by a lead-free polytetrafluoroethylene (PTFE) layer for providing sliding engagement with the other of the cylinder and the piston.

The method may further comprise mounting a second bearing to one of the cylinder and the piston, where the second bearing includes a second bearing surface formed by a lead-free PTFE layer that provides sliding engagement with the other of the cylinder and the piston.

According to another aspect of the invention, an aircraft shock strut includes a cylinder, a piston telescopically movable within the cylinder, and a first bearing on one of the cylinder and the piston. The first bearing has a first bearing surface providing sliding engagement with the other of the cylinder and the piston. The first bearing surface has a coefficient of dynamic friction that is less than 0.08 when providing sliding engagement with the other of the cylinder and the piston.

According to another aspect of the invention, an aircraft shock strut includes a cylinder, a piston telescopically movable within the cylinder, and a first bearing on one of the cylinder and the piston. The first bearing has a first bearing surface providing sliding engagement with the other of the cylinder and the piston. The first bearing surface has a coefficient of static friction that is less than 0.09 when slidingly engaging the other of the cylinder and the piston.

According to another aspect of the invention, an aircraft shock strut includes a cylinder, a piston telescopically movable within the cylinder, and a first bearing on one of the cylinder and the piston. The first bearing has a first bearing surface providing sliding engagement with the other of the cylinder and the piston. The first bearing surface is formed by a lead-free polytetrafluoroethylene (PTFE) layer that has a coefficient of static friction of less than 0.160 when slidingly engaging the other of the cylinder and the piston.

The foregoing and other features of the invention are hereinafter fully described and particularly pointed out in the claims, the following description and annexed drawings setting forth in detail a certain illustrative embodiment of the invention, this embodiment being indicative, however, of but one of the various ways in which the principles of the invention may be employed.

### BRIEF DESCRIPTION OF THE DRAWINGS

FIG. 1 is a schematic elevation view of a simplified landing gear assembly incorporating a shock strut in accordance with the present invention.

FIG. 2 is a partial cross-sectional view of the shock strut of FIG. 1 taken along the line 2-2 thereof.

FIG. 3 is a perspective view of a bearing in accordance with the present invention.

FIG. 4 is an end view of FIG. 3.

FIG. 5 is an enlarged sectional view of a portion of the bearing of FIG. 4.

FIG. 6 is a perspective view of an exemplary upper bearing on an upper bearing carrier used in the shock strut of FIG. 1.

FIG. 7 is cross-sectional view of FIG. 6 taken along line 7-7.

FIG. 8 is a perspective view of an exemplary lower bearing on a lower bearing carrier used in the shock strut of FIG. 1.

FIG. 9 is a cross-sectional view of FIG. 8 taken along line 9-9.

### DETAILED DESCRIPTION

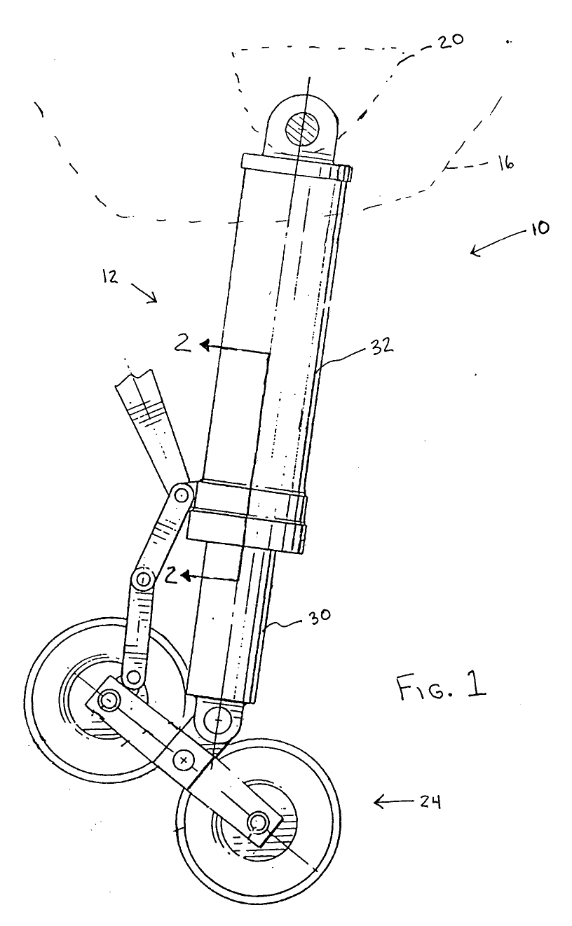

FIG. 1 presents a simplified aircraft landing gear assembly 10, including an exemplary aircraft shock strut 12, shown mounted at an upper end to an aircraft structure 16 by an attachment member 20. The references herein to a shock strut or an aircraft shock strut refer to shock struts employed in aircraft landing gear. The lower end of the shock strut 12 is attached to a wheel assembly 24. The aircraft structure 16, attachment member 20 and wheel assembly 24 are shown in simple or outline form, while other structures such as locking mechanisms and retracting mechanisms are not shown in FIG. 1 in order to avoid obscuring the shock strut. Various arrangements of such structures are known in the art and are not critical to the description or understanding of the invention.

The shock strut 12 includes a piston 30 and a cylinder 32, which may be cylindrical as is customary, or some other shape, if desired. The shock strut is configured for attachment to the aircraft structure 16 and the wheel assembly 24 such that the piston communicates forces to and from the wheel assembly 24. The cylinder 32 receives the piston 30 in a manner that permits relative telescoping movement between the cylinder 32 and the piston 30 to absorb and dampen shock forces being transmitted to the aircraft structure 16. As is described more fully below, one or more bearings in accordance with the present invention are disposed between the cylinder 32 and the piston 30 for providing sliding engagement between the cylinder 32 and the piston 30.

It will be appreciated that the present invention is applicable to a variety of aircraft shock strut types and geometries, provided that the aircraft shock strut includes at least one bearing. Because the detailed workings of a typical aircraft shock strut are understood by those of ordinary skill in the art, an overview of shock strut operation is provided for the sake of brevity. The piston 30 and the cylinder 32 generally define a sealed elongate chamber at least partially filled with a liquid, such as hydraulic fluid or oil. A portion of the chamber, e.g., an upper portion of the chamber, may be filled with a gas, such as nitrogen, as is common in an air-over-oil type of shock strut.

In operation, compression of the shock strut 12 causes the piston 30 to move into the cylinder 32, thereby reducing the volume of the sealed chamber, and compressing the portion filled with gas. The compressed gas stores energy in a manner similar to a spring. Relative telescoping movement of the piston into the cylinder pumps liquid from a generally lower dynamic liquid chamber, typically through an orifice plate, into a pneumatic chamber as the shock strut 12 is compressed, thereby increasing resistance to compression, while simultaneously dissipating compression energy. As the piston 30 moves into the cylinder 32, a metering pin moves into an orifice opening in the orifice plate, effectively reducing the flow area through the orifice opening and increasing resistance to further compression.

Part of the work expended in compressing the shock strut 12 is stored as recoverable spring energy in the portion filled with gas, which resiliently suspends the aircraft structure 16 while taxiing on the ground, and which also allows the piston and the cylinder to return to an extended position after the compression force is removed, such as after takeoff.

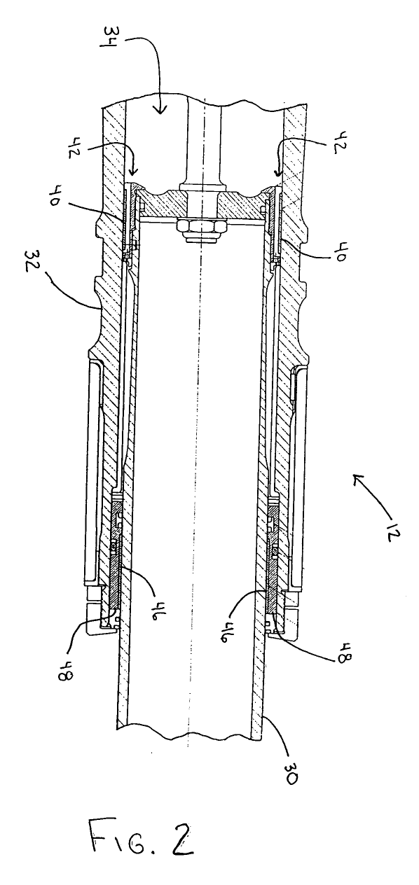

Referring now to FIG. 2, a portion, e.g., a lower portion, of an aircraft shock strut 12 is presented. As illustrated, the shock strut 12 includes a piston 30 and a cylinder 32 for receiving the piston 30 in a manner that permits relative telescoping movement between the cylinder 32 and the piston 30, and defines there between an elongate chamber 34 filled with a liquid and a gas. In one embodiment the cylinder is comprised of steel. Alternatively, the cylinder is comprised of titanium. In yet another embodiment, the cylinder and/or the piston are plated or otherwise coated with a suitable material, such as chrome or tungsten carbide. The cylinder and the piston can be comprised of any suitable metal (or other material) without departing from the scope of the present invention.

A first bearing 40, e.g., an upper bearing, is disposed between the piston 30 and the cylinder 32. In the illustrated embodiment, the first bearing 40 is mounted or otherwise coupled to the piston 30 via a first bearing carrier 42, and has a bearing surface that contacts and provides sliding engagement with the cylinder 32. As illustrated, a second bearing 46, e.g. a lower bearing, is mounted or otherwise coupled to the cylinder 32 via a second bearing carrier 48, and has a bearing surface contacting and providing sliding engagement with the piston 30. As is described more fully below, the bearing surface of the first bearing 40 and the bearing surface of the second bearing 46 are comprised of a lead-free polytetrafluoroethylene (PTFE) material. The lead-free PTFE material provides desirable friction performance and reduces or eliminates problems with stick-slip or “stiction,” while avoiding problems with discoloration and/or contamination of the hydraulic fluid within the shock strut.

As used herein, the terms “upper” and “lower,” such as “upper bearing” and “lower bearing,” refer to relative position, and are intended to facilitate explanation of the invention. It is not intended to limit the invention to any specific orientation of the aircraft shock strut unless otherwise indicated.

While the present invention is being described with respect to a first bearing and a second bearing both having bearing surfaces comprised of a lead-free PTFE material layer, it is contemplated that only one of the bearings, e.g., only the lower bearing or only the upper bearing, may include a bearing surface formed of a lead-free PTFE material layer (with the other bearing including a bearing surface formed of a different type of material or layer). Further, in the illustrated embodiment, the first and second bearings 40 and 46 are generally cylindrical in shape, corresponding to a generally cylindrical cylinder 32 and piston 30. However, it is to be appreciated that the first and/or second bearings can be of some other shape or geometry if the cylinder and piston are of some other shape or geometry, without departing from the scope of the present invention.

In addition, while the embodiment illustrated in FIG. 2 depicts the first bearing 40 being mounted to the piston 30, and the second bearing 46 being mounted to the cylinder 32, the invention is not intended to be limited to this configuration. Rather, one or both of the first bearing 40 and the second bearing 46 can be mounted to the piston 30 or the cylinder 32 without departing from the scope of the present invention.

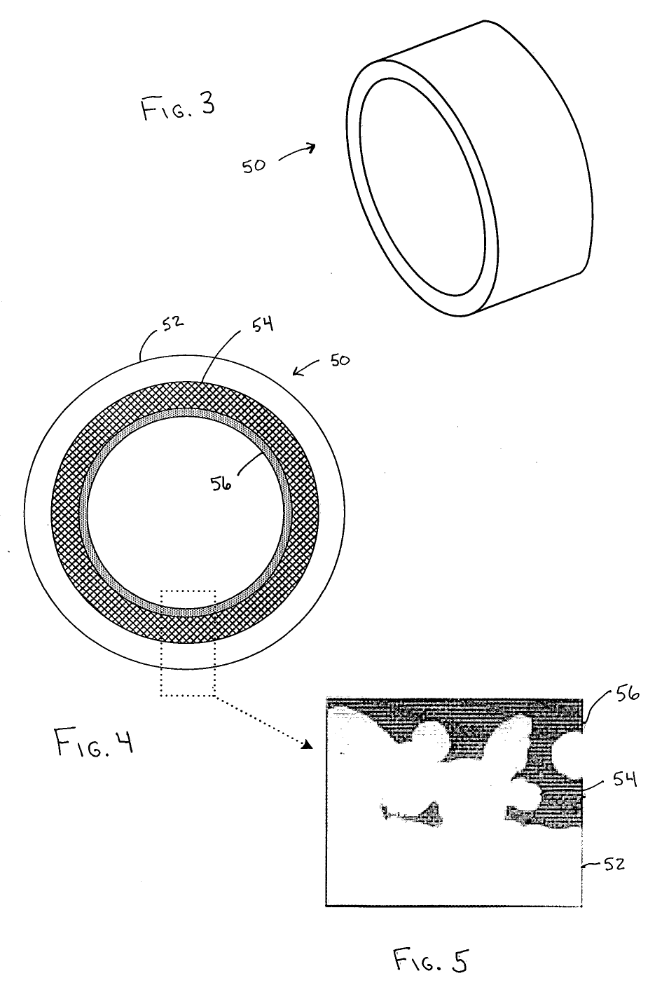

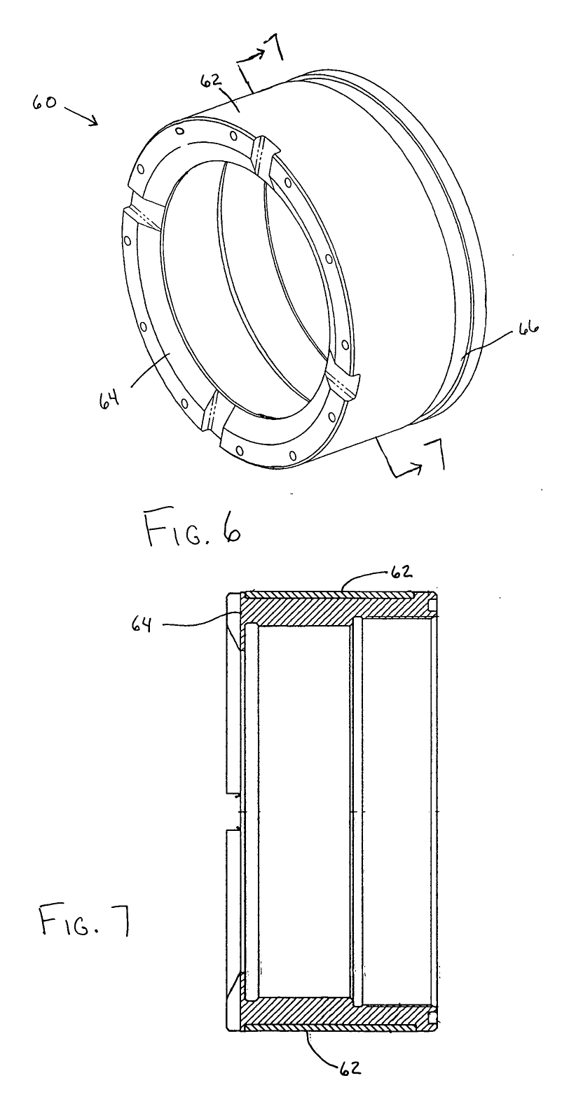

Referring now to FIGS. 3-5, an exemplary bearing 50 in accordance with the present invention is illustrated. The bearing 50 includes a support structure 52, an intermediate layer 54, e.g., a porous layer, on the support structure 52, and a bearing surface layer 56 (also referred to simply as a bearing surface) on and/or impregnated into the intermediate layer 54. In a preferred embodiment, the intermediate layer 54 is a porous layer, and the bearing surface layer 56 is made of a lead-free polytetrafluoroethylene (PTFE) material on and/or impregnated into the porous layer. In the illustrated embodiment, the porous layer 54 is shown to be on an inner surface of the support structure 52, e.g., radially inward relative to the support structure 52, with the bearing surface 56 on or impregnated into an inner surface of the porous layer 54. However, it is to be appreciated that the bearing surface may be disposed radially outward relative to the support structure 52. That is, the intermediate or porous layer 54 may be on an outer surface of the support structure 52, with the bearing surface layer 56 being on and/or impregnated into an outer surface of the intermediate or porous layer 54 (see the exemplary bearing illustrated in FIG. 6).

In a preferred embodiment, the support structure 52 is comprised of aluminum bronze. One advantage of a support structure comprised of aluminum bronze is that damage to the cylinder and/or the piston would be reduced if the bearing surface were to fail. However, it is to be appreciated that the support structure may be comprised of any material operable to support the porous layer 54 and withstand the process of impregnating and sintering the bearing material layer 56. For example, the support structure may be comprised of another metal, such as a low carbon steel, a metal-plated material, a non-metal material or the like.

The porous layer 54 may comprise any material operable to key or otherwise link the bearing surface material layer 56 to the support structure 52, including, but not limited to, bronze particles sintered to the support structure, copper particles sintered to the support structure and the like.

The bearing surface layer 56 is comprised of a lead-free PTFE material that is on and/or impregnated into the porous layer 54. It will be appreciated that the lead-free PTFE bearing surface layer material described herein provides a sufficiently low coefficient of friction, minimal stick-slip or stiction, and resistance to corroding or otherwise contaminating the hydraulic fluid or oil within the shock strut. In a preferred embodiment, the bearing 50 has a bearing surface 56 comprising a lead-free PTFE material sold under the trademark DP4™ by GGB (formerly Glacier Garlock Bearings).

In one embodiment, the lead-free PTFE material comprises a continuous consolidated structure including a continuous PTFE matrix and discrete particles of a lead-free additive material. The particles may be microscopically and macroscopically homogeneously distributed with the PTFE polymer matrix.

In an exemplary embodiment, the additive material may comprise a material suitable for incorporation into an extruded unsintered tape, such that the tape is operable to be impregnated into the porous layer disposed on the support structure and operable to withstand the processing temperatures used to consolidate the bearing surface material layer.

Tapes that are operable to be impregnated into a porous layer disposed upon a support structure may include those that can be impregnated without compacting or closing up the pores of the porous layer, or those that can suitably adhere to the porous layer. Any amount of additive material may be included in the bearing material layer. In one embodiment, the amount of additive material included in the bearing material layer is such that enough PTFE is present to form a continuous consolidated layer.

In one embodiment, the additive material comprises an inorganic particulate filler, such as, but not limited to, ionic fluorides including calcium fluoride, magnesium fluoride, tin fluoride; metal oxides, including, for example, iron oxide, aluminum oxide, titanium dioxide, zinc oxide; and metal hydroxides such as aluminum hydroxide. In another embodiment, the additive material comprises an inorganic particulate filler comprising calcium fluoride. The particle size of the inorganic particulate filler may be determined by a size operable to improve cavitation erosion resistance and wear resistance while retaining desirable low friction properties. In accordance with an embodiment of the wherein the additive material comprises calcium fluoride, the calcium fluoride may have a mean diameter particle size of less than or equal to 10 microns. In another embodiment, the calcium fluoride may have a mean diameter particle size of less than or equal to 2 microns. In another embodiment, the amount of inorganic particulate filler in the bearing material layer is between 10 to 30% by volume. Of course, other particle sizes and concentrations are contemplated within the scope of the present invention. In another embodiment, the additive material may comprise polyphenylene sulphide particles. In an embodiment, the amount of polyphenylene sulphide in the bearing material layer is between 30 and 70% by volume. In another embodiment, the amount of polyphenylene sulphide is 50% by volume. In another embodiment, the polyphenylene sulphide has a mean diameter particle size of less than or equal to 60 microns. In another embodiment, the polyphenylene sulphide has a mean diameter particle size of less than or equal to 20 microns.

In another embodiment, the bearing material layer may further comprise an organic filler material including, but not limited to, tetrafluoroethylene-perfluoroalkylvinylether copolymers, tetrafluoroethylene-hexafluoropropylene copolymer, tetrafluoroethylene propylene ether polymer, tetrafluoroethylene-ethylene copolymers, polychlorotrifluoroethylene polymers, polychlorotrifluoroethylene-ethylene copolymers, hexafluoroisobutylene polymers, hexafluoroisobutylene-vinylidene fluoride copolymers or hexafluoro propylene polymer. A melt processable organic filler material, such as those listed above, may be included to modify the crystallinity of the PTFE in the extruded unsintered tape and/or the bearing material layer.

The extruded unsintered tape that makes up the bearing surface layer may be produced by any suitable method, including the method described in U.S. Pat. No. 5,697,390, incorporated herein by reference in its entirety, where PTFE particles and additive particles are mixed with an air impact pulverizer and then extruded to form a tape.

The extruded unsintered tape may be impregnated into the porous layer by means of a rolling mill, for example. The step of impregnating is conducted under conditions and temperatures that do not sinter the tape or melt any polymer material in the tape.

After impregnating the extruded unsintered tape into a porous layer to form a bearing surface material layer, the bearing surface material layer is sintered to produce a three-layer composite material comprising a continuous consolidated bearing material layer. In one embodiment, all of the PTFE in the bearing material layer is sintered.

As used herein, sintering or consolidating a tape or bearing surface material layer refers to heating PTFE to its melting point or above. When PTFE is heated above its melting point, which may be between 350 degrees Celsius and 425 degrees Celsius, the PTFE is consolidated or densified. Before heating above its melting point, PTFE is relatively soft and can be manipulated into structures such as a porous layer with minimal applied force and without heat.

An advantage of the bearings and the method of manufacture described herein is that the bearing surface can be substantially blister free because the extruded unsintered tape does not require liquid lubricant in an amount that could cause blistering under the conditions used to sinter the tape.

Further details concerning the composition of and process of making the lead-free PTFE bearing surface material layer are discussed in publication number WO 2004/079217, which is incorporated herein by reference in its entirety.

It is to be appreciated that the bearing in accordance with the present invention provides desirable friction performance, e.g., a low coefficient of dynamic and/or static friction for sliding engagement with the piston or the cylinder. In one exemplary embodiment, the bearing, when employed in a functional, fluid-containing shock strut, has a coefficient of dynamic friction that is less than 0.08 when providing sliding engagement with the cylinder or the piston. In another exemplary embodiment, the bearing, when employed in a functional, fluid-containing shock strut, has a coefficient of static friction that is less than 0.09 when slidingly engaging the cylinder or the piston.

Further, the bearing described herein minimizes or otherwise eliminates stiction. It is believed that the bearing described herein minimizes or otherwise eliminates the occurrence of stiction because of the relatively small difference between the coefficient of static friction and the coefficient of dynamic friction when providing sliding engagement with the cylinder or the piston. In one exemplary embodiment, the bearing, when employed in a functional, fluid-containing shock strut, has a coefficient of static friction and a coefficient of dynamic friction that differ by less than 0.045. Because the bearing surface material includes lead-free PTFE, this desirable performance is provided without contamination of the fluid within the shock strut.

In the above-identified exemplary embodiments in which exemplary coefficients of friction are provided, the cylinder and/or the piston may be comprised of steel that is coated, e.g., coated with chrome or coated with tungsten carbide, or uncoated and polished. It will be appreciated that the above-identified exemplary coefficients of friction may vary depending on, among other things, the material and the finish of the cylinder and/or piston against which the bearing slides.

While the bearing in accordance with the present invention has been described generally with reference to FIGS. 3-5, FIGS. 6-9 provide exemplary upper and lower bearings.

FIGS. 6 and 7 depict an exemplary first or upper bearing assembly 60 that includes a bearing 62 located radially outward in relation to the upper bearing carrier 64, i.e., on the outside diameter of the upper bearing carrier 64. In the illustrated exemplary embodiment, the first or upper bearing 62 is configured to mount to the piston of the shock strut via the upper bearing carrier 64, with the bearing surface of the upper bearing 62 providing sliding engagement with the cylinder. It is to be appreciated that the first or upper bearing carrier 64 may take any suitable geometry or configuration without departing from the scope of the present invention. For example, in the illustrated embodiment, the first or upper bearing carrier 64 includes a recess 66, which may function as or otherwise house a retainer. The bearing carrier can be made from any suitable material, such as aluminum, a non-metallic composite material or the like. In the illustrated embodiment, the first or upper bearing is configured as a cylindrical sleeve mountable to the bearing carrier.

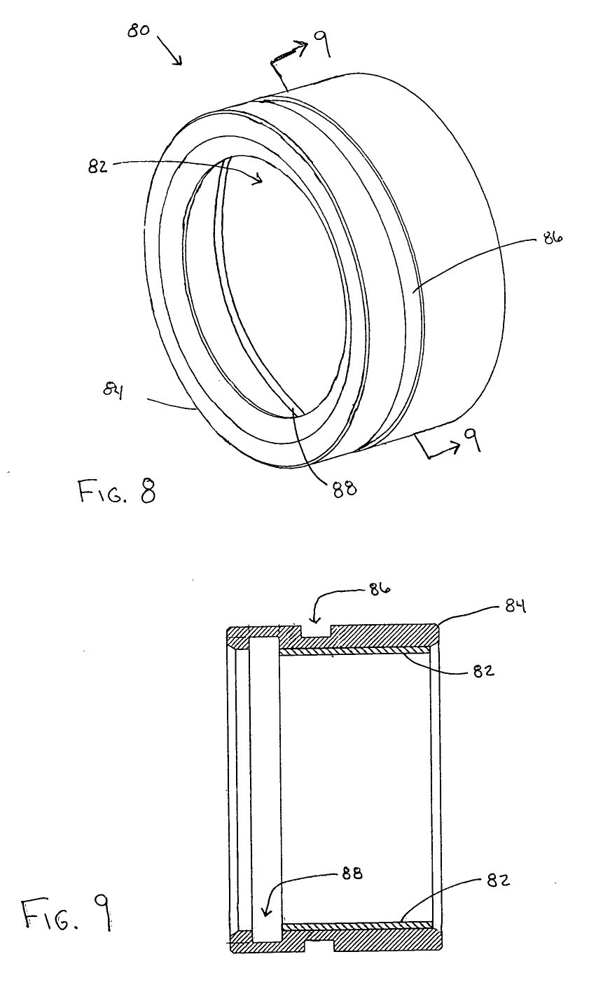

FIGS. 8 and 9 depict an exemplary second or lower bearing assembly 80 in which the bearing 82 is located radially inward in relation to the bearing carrier 84, i.e., on the inside diameter of the bearing carrier 84. In the illustrated exemplary embodiment, the second or lower bearing 82 is configured to mount to the cylinder of the shock strut via the bearing carrier 84, with bearing surface providing sliding engagement with the piston. As stated above with reference to FIGS. 6 and 7, it is to be appreciated that the second or lower bearing carrier 84 may take any suitable geometry or configuration without departing from the scope of the present invention. For example, in the illustrated embodiment, the second or lower bearing carrier 84 includes a first recess 86, which may function to house a static seal, e.g., a back up sealing ring, and a second recess 88, which may function to house a dynamic seal assembly. In the illustrated embodiment, the second or lower bearing is configured as a cylindrical sleeve mountable to the bearing carrier.

Although the invention has been shown and described with respect to certain illustrated embodiment, equivalent alterations and modifications will occur to others skilled in the art upon reading and understanding the specification and the annexed drawings. For example, although an embodiment of the invention directed to an aircraft strut is described, a shock absorber provided by the present invention may have other applications other than aeronautical applications. In particular regard to the various functions performed by the above described integers (components, assemblies, devices, compositions, etc.), the terms (including a reference to a “means”) used to describe such integers are intended to correspond, unless otherwise indicated, to any integer which performs the specified function (i.e., that is functionally equivalent), even though not structurally equivalent to the disclosed structure which performs the function in the herein illustrated embodiments of the invention.

What is claimed is:

1. An aircraft shock strut comprising:
a cylinder;
a piston telescopically movable within the cylinder; and
a first bearing on one of the cylinder and the piston, the first bearing having a first bearing surface providing sliding engagement with the other of the cylinder and the piston;
wherein the first bearing comprises a support structure and a porous layer on the support structure, the first bearing surface being formed by an extruded bearing material layer impregnated into the porous layer, wherein the bearing material layer is a continuous consolidated structure comprising a continuous polytetrafluoroethylene (PTFE) matrix and discrete particles of an additive material, and wherein the bearing material layer has a portion above the porous layer.

2. The aircraft shock strut according to claim 1, wherein the bearing material layer is substantially blister free.

3. The aircraft shock strut according to claim 1, wherein the additive material includes inorganic filler material.

4. The aircraft shock strut according to claim 3, the bearing material layer comprises 10% to 30% by volume of inorganic filler material.

5. The aircraft shock strut according to claim 3, wherein the inorganic filler material comprises calcium fluoride.

6. The aircraft shock strut according to claim 1, wherein the additive material comprises polyphenylene sulphide.

7. The aircraft shock strut according to claim 6, wherein the bearing, material layer comprises 30% to 70% by volume of polyphenylene sulphide.

8. The aircraft shock strut according to claim 1, wherein the support structure is comprised of aluminum bronze.

9. The aircraft shock strut according to claim 1, wherein the porous layer comprises bronze particles sintered to the support structure.

10. The aircraft shock strut according to claim 1, further comprising a second bearing mounted to the other of the cylinder and the piston, the second bearing including a second support structure and a second bearing surface providing sliding engagement with one of the cylinder and the piston.

11. The aircraft shock strut according to claim 10, wherein the second bearing surface is comprised of lead-free polytetrafluoroethylene (PTFE) material.

12. The aircraft shock strut according to claim 10, wherein the first bearing is an upper bearing mounted to the piston via an upper bearing carrier, and the second bearing is a lower bearing mounted to the cylinder via a lower bearing carrier.

13. The aircraft shock strut according to claim 1, further comprising a second bearing mounted to one of the cylinder and the piston, the second bearing including a second support structure and a second bearing surface providing sliding engagement with the other of the cylinder or the piston.

14. The aircraft shock strut according to claim 13, wherein the second bearing surface is comprised of lead-free polytetrafluoroethylene (PTFE) material.

15. The aircraft shock strut according to claim 13, wherein the first bearing is an upper bearing mounted to the piston via an upper bearing carrier, the first bearing surface providing sliding engagement with the cylinder.

16. The aircraft shock strut according to claim 13, wherein the second bearing is a lower bearing mounted to the cylinder via a lower bearing carrier, the second bearing surface providing sliding engagement with the piston.

17. An aircraft landing gear assembly including the aircraft shock strut of claim 13.

18. The landing gear assembly according to claim 17, wherein the landing gear assembly is a nose landing gear assembly.

19. The landing gear assembly according to claim 17, wherein the landing gear assembly is a main landing gear assembly.

20. An aircraft shock strut comprising:
a cylinder;
a piston telescopically movable within the cylinder; and
a first bearing on one of the cylinder and the piston, the first bearing having a first bearing surface providing sliding engagement with the other of the cylinder and the piston;
wherein the first bearing surface is formed by a lead-free polytetrafluoroethylene (PTFE) material layer, the lead-free PTFE material layer having a coefficient of static friction and a coefficient of dynamic friction that differ by less than 0.045 while providing sliding engagement with the other of the cylinder and the piston.

21. The aircraft shock strut according to claim 20, wherein the cylinder and/or the piston are plated with chrome or tungsten carbide.

22. The aircraft shock strut according to claim 20, wherein the coefficient of dynamic friction is less than 0.100.

23. A method of preventing stick-slip in an aircraft landing gear including at least one shock strut, the at least one shock strut including a cylinder and a piston telescopically movable within the cylinder, the method comprising mounting a first bearing to one of the cylinder and the piston, the first bearing having a first bearing surface formed by a lead-free polytetrafluoroethylene (PTFE) layer providing sliding engagement with the other of the cylinder and the piston.

24. The method according to claim 23, further comprising mounting a second bearing to one of the cylinder and the piston, the second bearing including a second bearing surface having a lead-free PTFE layer providing sliding engagement with the other of the cylinder and the piston.

25. The method according to claim 24, wherein each of the first bearing and the second bearing includes a support structure, a porous layer on the support structure and the lead-free PTFE layer impregnated into the porous layer.

26. The method according to claim 24, wherein the lead-free PTFE layers of the first and second bearing surfaces include a lead-free PTFE material layer containing a an inorganic filler material.
